(19) United States
(12) Patent Application Publication
(10) Pub. No.: US 2023/0072136 A1
(43) Pub. Date: Mar. 9, 2023

(54) EXTENDABLE SHOWER APPARATUS

(71) Applicant: YUN-XIAO CUI, New Taipei City (TW)

(72) Inventor: YUN-XIAO CUI, New Taipei City (TW)

(21) Appl. No.: 17/466,836

(22) Filed: Sep. 3, 2021

(51) Int. Cl. B05B 1/18; E03C 1/02

(52) U.S. Cl. CPC B05B 1/185; E03C 1/025

(57) ABSTRACT

An extendable shower apparatus is disposed with a rain shower head and a handheld shower and includes a shower panel, a lateral spray assembly, and a switch. The shower panel is connected to the rain shower head and the handheld shower and has a pivotally connecting portion. The lateral spray assembly is movably disposed to the shower panel and includes a swinging arm and a shower head. The swinging arm is connected to the pivotally connecting portion to allow the lateral spray assembly to protrude out of a side of the shower panel. The shower head is disposed at an end of the swinging arm. The switch is adapted to control water to output from one of the rain shower head, the lateral spray assembly, and the handheld shower. Thus, the extendable shower apparatus could provide a function of lateral showering to fulfill the required demand of a user.

### BACKGROUND OF THE INVENTION

### Technical Field

The present invention relates generally to a showering apparatus, and more particularly to an extendable shower apparatus.

### Description of Related Art

So far, most of the showering apparatus on the market includes a showering panel, wherein the showering panel is mounted with a rain shower head and a handheld shower. The rain shower head could provide a user a waterfall-type showering experience. The handheld shower can be held and operated by a user's hand. Since the conventional rain shower head is fixed on to a top of the showering panel, the user can not adjust the showering angle. Besides, the water outputting area of the handheld shower is too small to satisfy various required demands of the user. Thus, the conventional showering apparatus needs to be improved to fulfill the required demands of the user.

### BRIEF SUMMARY OF THE INVENTION

In view of the above, the primary objective of the present invention is to provide an extendable shower apparatus for allowing water to be outputted laterally.

The present inventive subject matter provides an extendable shower apparatus including a rain shower head and a handheld shower and includes a shower panel, a lateral spray assembly, and a switch. The shower panel is connected to the rain shower head and the handheld shower and is disposed with a pivotally connecting portion. The lateral spray assembly is movably disposed to the shower panel and includes a swinging arm and a shower head, wherein the swinging arm is connected to the pivotally connecting portion, thereby allowing the lateral spray assembly to extend away from a side of the shower panel. The shower head is disposed on an end of the swinging arm that is away from the shower panel. The switch is disposed on the shower panel and is adapted to control water output from one of the rain shower head, the handheld shower, and the lateral spray assembly to output water.

With the aforementioned design, the extendable shower apparatus could provide user to shower by not only the rain shower head and the handheld shower, but also the lateral spray assembly that could be pivotally moved at the side of the shower panel. The user could adjust the angle between the lateral spray assembly and the shower panel in accordance with the necessity to alter the water outputting position of the lateral spray assembly, thereby meeting the requirement of the user.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the extendable shower apparatus of an embodiment according to the present invention;

FIG. 2 is a perspective view of the extendable shower apparatus of the embodiment according to the present invention seen from another perspective;

FIG. 3 is a partially exploded view of the extendable shower apparatus of the embodiment according to the present invention, showing the lateral spray assembly is exploded;

FIG. 4 is a front view of the extendable shower apparatus of the embodiment according to the present invention;

FIG. 5 is a sectional view taken along the 5-5 line in FIG. 4;

FIG. 6 is a sectional view taken along the 6-6 line in FIG. 4;

FIG. 7 is an enlarged partial view of a marked region 7 in FIG. 6

FIG. 8 is a schematic diagram of the extendable shower apparatus of the embodiment according to the present invention, wherein the lateral spray assembly is located at the transitional position;

FIG. 9 is a schematic diagram of the extendable shower apparatus of the embodiment according to the present invention, wherein the lateral spray assembly is located at the folded position; and

FIG. 10 is a schematic diagram of the extendable shower apparatus of the embodiment according to the present invention, wherein the lateral spray assembly is located at the extended position.

### DETAILED DESCRIPTION OF THE INVENTION

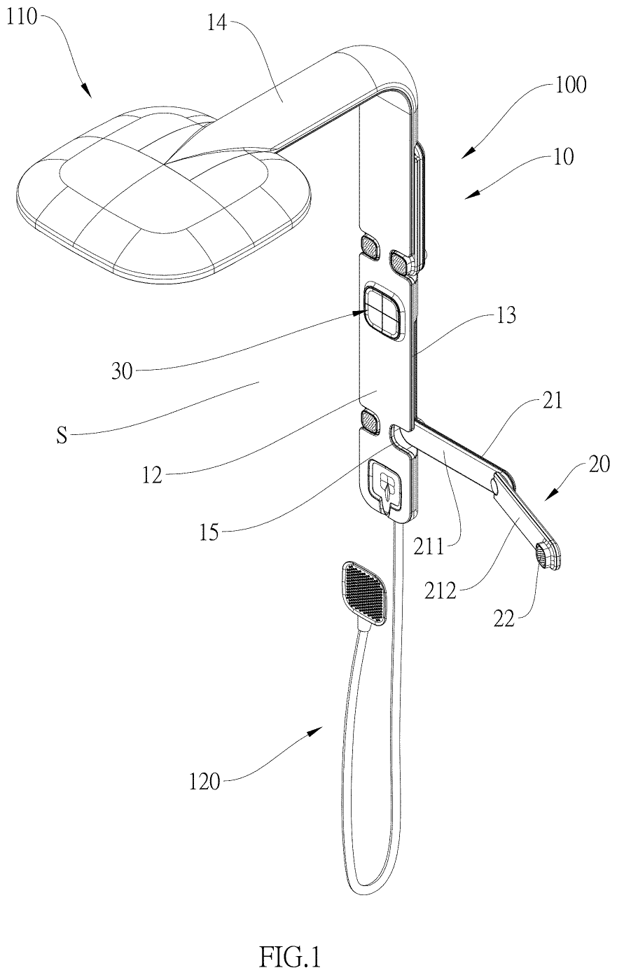

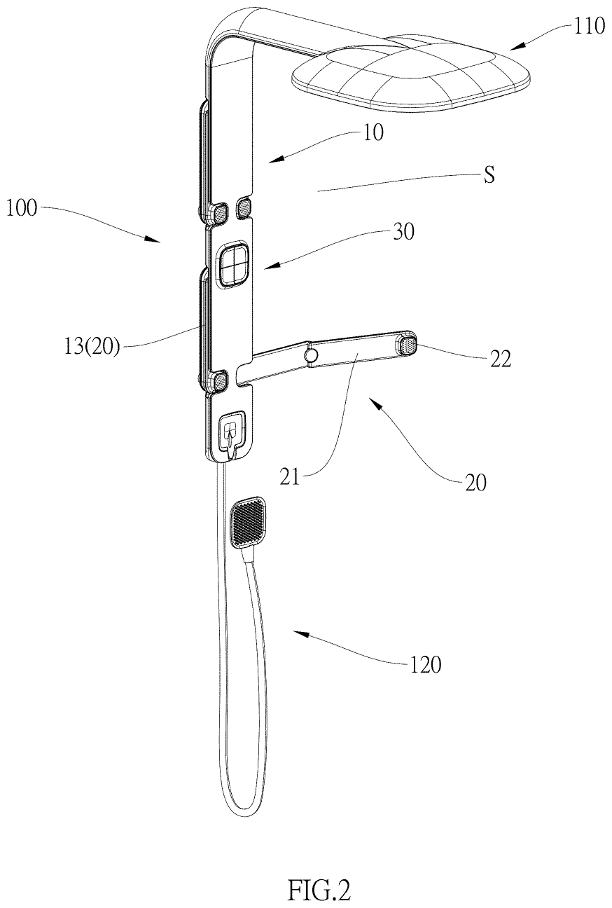

As illustrated in FIG. 1 and FIG. 2, an extendable shower apparatus 100 of an embodiment according to the present invention is disposed with a rain shower head 110 and a handheld shower 120 and includes a shower panel 10, four lateral spray assemblies 20, and a switch 30.

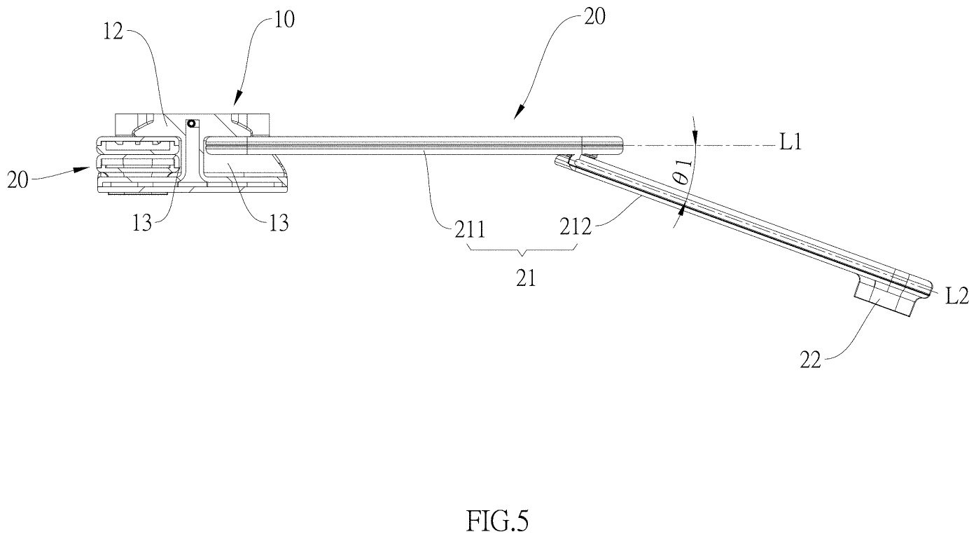

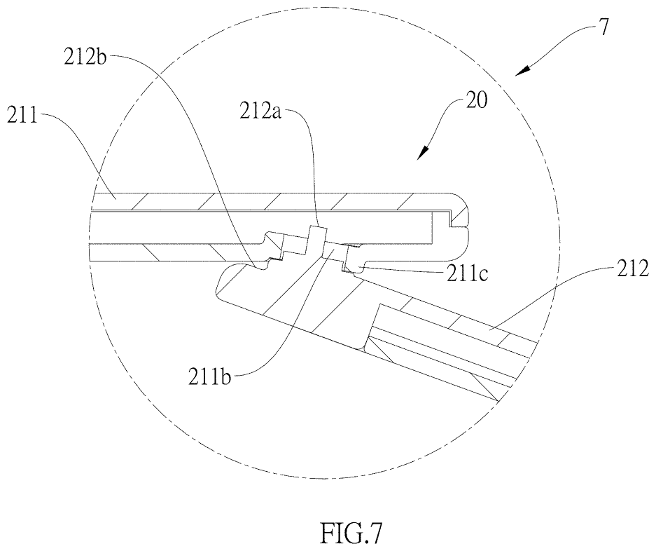

As illustrated in FIG. 1 and FIG. 7, the shower panel 10 is connected to the rain shower head 110 and the handheld shower 120 and includes four pivotally connecting portions 11. Each of the pivotally connecting portions 11 of the shower panel 10 is adapted to connect to one of the lateral spray assemblies 20. As illustrated in FIG. 1, FIG. 2, and FIG. 5, the shower panel 10 includes a body portion 12 of the shower panel and four receiving grooves 13. The body portion 12 of the shower panel 10 could be mounted on a wall of building and connected to the water source (not shown). The four receiving grooves 13 are respectively located at two sides of the body portion 12 of the shower panel. Each of the four receiving grooves 13 are disposed along an axial direction of the body portion 12 of the shower panel. In the current embodiment, two of the four receiving grooves 13 are located at one of the two sides of the body portion 12 of the shower panel. The other two of the four receiving grooves 13 are located at another one of the two sides of the body portion 12 of the shower panel. However, the receiving groove 13 is not limited to the above-mentioned. In another embodiment, a number of the pivotally connecting portions 11 could be at least one, and a number of the receiving grooves 13 could be at least one. In another embodiment, the receiving grooves 13 could be omitted, and the pivotally connecting portions 11 could be disposed on the body portion 12 of the shower panel.

The shower panel 10 includes a spout 14 which is engaged with a top portion of the body portion 12 of the shower panel, wherein the spout 14 and the body portion 12 are integrally formed as a monolithic unit. The spout 14 extends horizontally from the body portion 12 of the shower panel, so that a shower space S is formed between the body portion 12 and the spout 14. The rain shower head 110 is mounted to the spout 14 and faces toward the shower space S, so that the rain shower head 110 could spray toward the shower space S. The handheld shower 120 is mounted at a bottom portion of the body portion 12 of the shower panel. In other embodiments, the spout 14 could be omitted, as long as the rain shower head 110 is mounted on the top portion of the body portion 12 of the shower panel.

Each of the four lateral spray assemblies 20 are movably disposed to the shower panel 10 and includes a swinging arm 21, a shower head 22, and an inner tube 23. The swinging arm 21 is connected to the pivotally connecting portions 11 to allow the lateral spray assembly 20 could extend out of the shower panel 10. The shower head 22 is disposed on an end of the swinging arm 21 that is away from the shower panel 10. The inner tube 23 is a soft tube that is disposed in the swinging arm 21 and extends into the shower panel 10, wherein the inner tube 23 could be bent as the swinging arm 21 is pivotally swung.

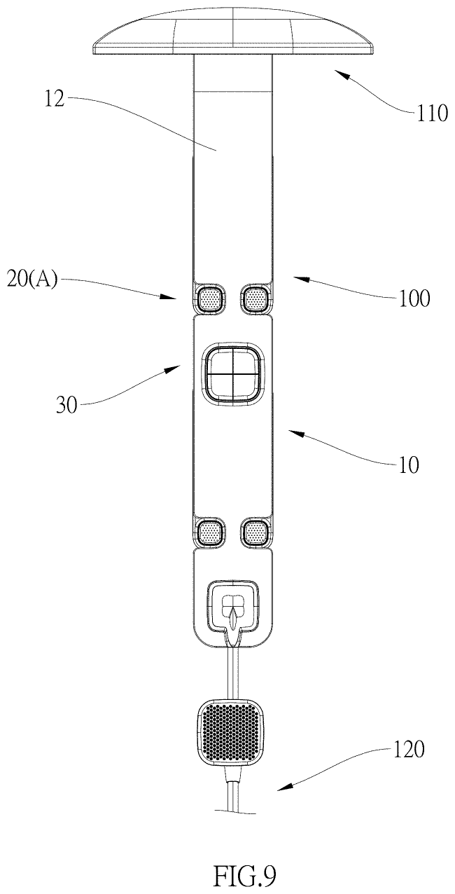

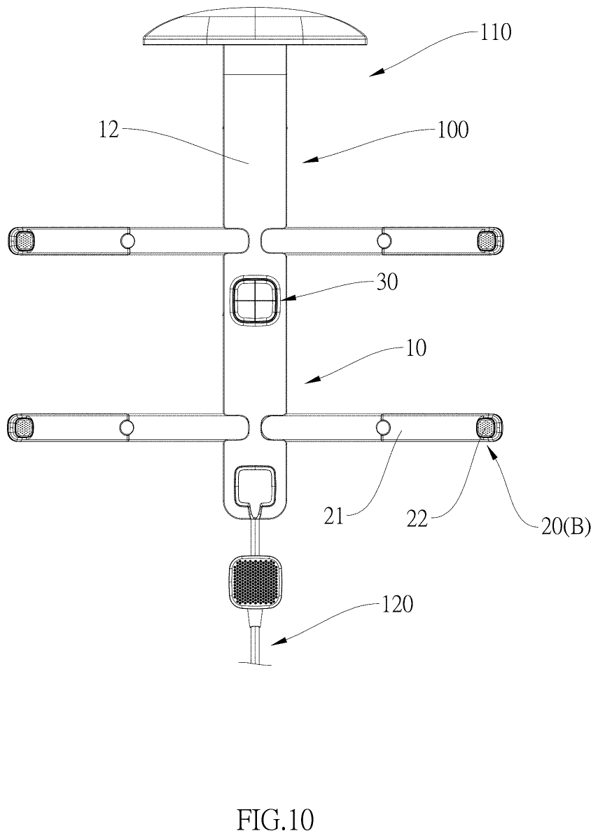

As illustrated in FIG. 9 and FIG. 10, each of the lateral spray assemblies 20 could be operated to move between a folded position A and an extended position B. When each of the lateral spray assemblies 20 is located at the folded position A (as shown in FIG. 9), the swinging arm 21 is received in the receiving grooves 13. Thus, each of the lateral spray assemblies 20 is hidden in the shower panel 10. When each of the lateral spray assemblies 20 is located at the extended position B (as shown in FIG. 10), the swinging arm 21 is pivotally swung outward to leave from the receiving grooves 13. The swinging arm 21 of each of the lateral spray assemblies 20 extends outward from the two sides of the shower panel 10, so that the shower head 22 could spray water toward the shower space S.

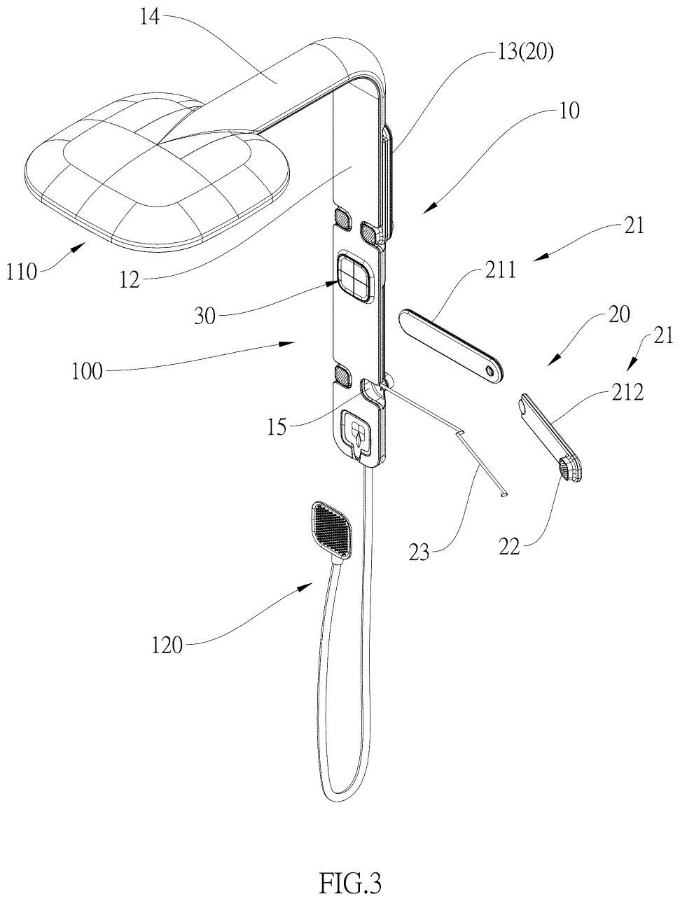

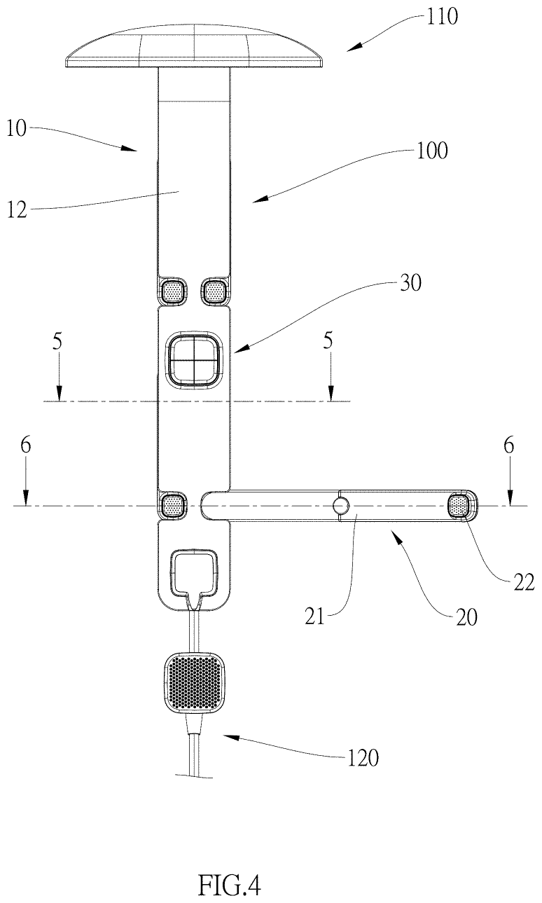

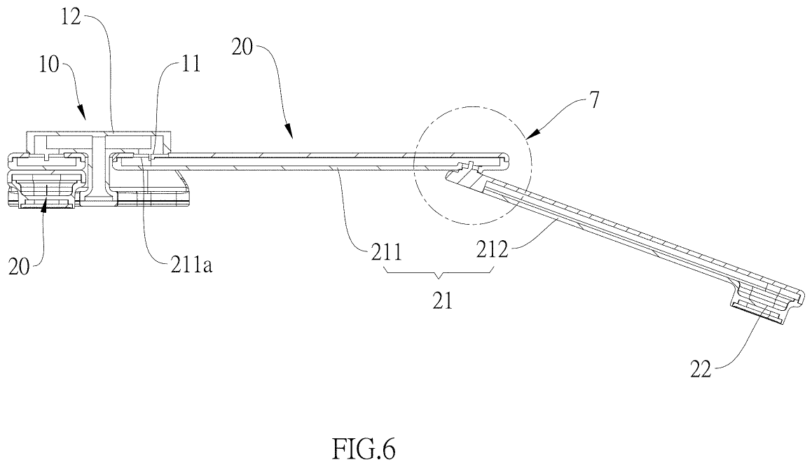

As illustrated in FIG. 3 to FIG. 7, the swinging arm 21 includes a first adjustable section 211 and a second adjustable section 212. An end of the first adjustable section 211 is connected to one of the pivotally connecting portions 11 of the shower panel 10, and another end of the first adjustable section 211 is pivotally connected to the second adjustable section 212. The first adjustable section 211 could be overlapped with the second adjustable section 212, thereby allowing the swinging arm 21 to be accommodated in the receiving grooves 13. As illustrated in FIG. 0.6 and FIG. 7, each of two ends of the first adjustable section 211 has a first connecting groove 211a and a second connecting groove 211b, respectively. The first connecting groove 211a and the second connecting groove 211b are respectively located at two sides of the first adjustable section 211 which faces opposite directions. The first adjustable section 211 is connected to one of the pivotally connecting portions 11 of the shower panel 10 via the first connecting groove 211a. The first adjustable section 211 has a protrusion 211c, wherein the protrusion 211c is disposed at an outer edge of the second connecting groove 211b. An end of the second adjustable section 212 has a pivotally connecting head 212a, and another end of the second adjustable section 212 is disposed with the shower head 22, wherein the pivotally connecting head 212a and the shower head 22 are located at different two sides of the second adjustable section 212. In the current embodiment, the pivotally connecting head 212a and the shower head 22 are located at two sides of the second adjustable that face opposite directions. The second adjustable section 212 is assembled to the second connecting groove 211b of the first adjustable section 211 via the pivotally connecting head 212a. The second adjustable section 212 has a recess 212b (as shown in FIG. 7), the recess 212b is disposed at a side of the pivotally connecting head 212a and is adapted to receive the protrusion 211c of the first adjustable section 211.

As illustrated in FIG. 5 and FIG. 9, when the lateral spray assembly 20 is located at the folded position A, the first adjustable section 211 and the second adjustable section 212 are overlapped with each other, and the protrusion 211c of the first adjustable section 211 is received into the recess 212b of the second adjustable section 212 (not shown), thereby storing the swinging arm 21 in the receiving grooves 13. Since each of the lateral spray assemblies 20 could be hidden in the two sides of the shower panel 10 without protrusion, the lateral spray assemblies 20 are space-efficient and looks clean and simple.

Besides, as illustrated in FIG. 3 and FIG. 9, the body portion 12 of the shower panel has four slots 15, each of the four slots 15 communicates with one of the receiving grooves 13 and faces toward the shower space S. When each of the lateral spray assemblies 20 is received in the receiving grooves 13, the shower head 22 of each of the lateral spray assemblies 20 is received in one of the slots 15. Each of the lateral spray assemblies 20 could output water toward the shower space S, so that each of the lateral spray assemblies 20 could also output water for showering when the lateral spray assemblies 20 are located at the folded position A. In other embodiment, a number of the slot 15 of the shower panel 10 could be merely one, even omitted.

As illustrated in FIG. 5 and FIG. 10, when the lateral spray assemblies 20 is pivotally swung from the folded position A to the extended position B, the protrusion 211c of the first adjustable section 211 could be disengaged from the recess 212b of the second adjustable section 212 to make the second adjustable section 212 is tiled by and abut against the protrusion 211c of the first adjustable section 211, thereby allowing the second adjustable section 212 to be tilted toward the shower space S relative to the first adjustable section 211. The first adjustable section 211 has a first axis L1, and the second adjustable section 212 has a second axis L2. A first angle θ1 between the first axis L1 and the second axis L2 is in a range of 10 to 50 degrees. Therefore, each of the lateral spray assemblies 20 could effectively spray water toward the shower space S, thereby providing a user an embracing shower experience.

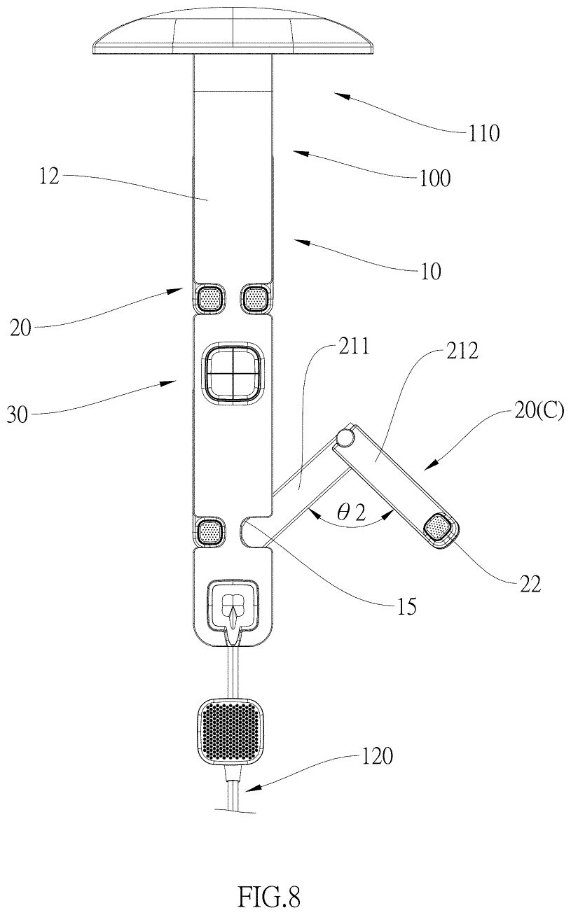

As illustrated in FIG. 8, each of the lateral spray assemblies 20 could be operated to move to a transitional position C, wherein the transitional position C is a position between the folded position A and the extended position B. When the lateral spray assemblies 20 located at the transitional position C, the swinging arm 21 is pivotally swung outward to disengage from the receiving groove 13 and the swinging arm 21 is curved relative to the shower panel 10 to form a second angle θ2 between the first adjustable section 211 and the second adjustable section 212, wherein the second angle θ2 is in a range of 10 to 80 degrees. With such design, a user could freely adjust the angle between the first adjustable section 211 and the second adjustable section 212 to change the position of the shower head 22 of each of the lateral spray assemblies 20, thereby fulfilling a required demand of the user.

In other embodiment, a shape of the lateral spray assembly 20 and a number of the lateral spray assembly 20 could be adjusted in accordance with a required demand. For example, the number of the lateral spray assembly 20 could be at least one, and the swinging arm 21 could be constituted by a single movable arm (without two adjustable sections). Alternatively, the first adjustable section 211 of the swinging arm 21 is not limited to be disposed with the first connecting groove 211a and the second connecting groove 211b, and the second adjustable section 212 is not limited to include the pivotally connecting head 212a. The first adjustable section 211 and the second adjustable section 212 could be connected to each other via any structure that could provide a pivotal connection therebetween. The protrusion 211c of the first adjustable section 211 and the recess 212b of the second adjustable section 212 could be substituted by any structure that could achieve the same function of the protrusion 211c and the recess 212b. Additionally, when the lateral spray assembly 20 is located at the folded position A, the lateral spray assembly 20 is not limited to be received in the receiving grooves 13 of the shower panel 10. For example, when the receiving grooves 13 of the shower panel 10 are omitted, each of the lateral spray assemblies 20 could be stored behind or in front of the shower panel 10 when the spray assembly 20 is located at the folded position A.

The switch 30 is disposed on the shower panel 10, the switch 30 is adapted to control water to output through one of the outputs including the rain shower head 110, the handheld shower 120, and the lateral spray assemblies 20. In the current embodiment, the switch 30 includes a switching button (not shown). When the user presses the switching button, the switch 30 controls the valve core (not shown) in the shower panel 10 to allow one of the rain shower head 110, the handheld shower 120, and the lateral spray assemblies 20 to output water.

With such design, the extendable shower apparatus 100 provides not only the rain shower head 110 and the handheld shower 120, but also the lateral spray assemblies 20 which could be pivotally moved at one of the two lateral sides of the shower panel 10. The user could adjust a position of the lateral spray assemblies 20 to change a water outputting position, thereby fulfilling the required demand of showering

Additionally, the lateral spray assemblies 20 could be manipulated to move among the folded position A, the extended position B, and the transitional position C. When the lateral spray assemblies 20 is located at the folded position A, the swinging arm 21 of each of the lateral spray assemblies 20 could be correspondingly received in one of the receiving grooves 13 of the shower panel 10. Since each of the lateral spray assemblies 20 could be stored in the two sides of the shower panel 10 without being exposed, the lateral spray assemblies 20 could be space-efficient, and the extendable shower apparatus 100 looks clean and simple. When the lateral spray assemblies 20 is located at the extended position B, the swinging arm 21 is pivotally swung outward to disengage from the receiving grooves 13 and radially extends from the two sides of the shower panel 10. Since the second adjustable section 212 tilts toward the shower space S relative to the first adjustable section 211, each of the lateral spray assemblies 20 could output water to the shower space S effectively, thereby making the user feel like being embraced or surrounded by water. When the lateral spray assemblies 20 are located at the transitional position C, the swinging arm 21 is bent relative to the shower panel 10, the user could adjust the angle between the first adjustable section 211 and the second adjustable section 212 (namely, second angle θ2 as mentioned above) in accordance with the required demand to achieve the objective to have lateral water output.

It must be pointed out that the embodiment described above is only a preferred embodiment of the present invention. All equivalent structures which employ the concepts disclosed in this specification and the appended claims should fall within the scope of the present invention.

What is claimed is:

1. An extendable shower apparatus comprising a rain shower head and a handheld shower, wherein the extendable shower apparatus comprises:
a shower panel connected to the rain shower head and the handheld shower and disposed with at least one pivotally connecting portion;
at least one lateral spray assembly movably disposed to the shower panel and comprising a swinging arm and a shower head, wherein the swinging arm is connected to the at least one pivotally connecting portion, thereby allowing the at least one lateral spray assembly to extends away from a side of the shower panel, and the shower head is disposed on an end of the swinging arm that is away from the shower panel; and
a switch disposed on the shower panel and adapted to control water output from one of the rain shower head, the handheld shower, and the at least one lateral spray assembly to output water.

2. The extendable shower apparatus as claimed in claim 1, wherein the shower panel has at least one receiving groove, and a shower space is formed between the rain shower head and the shower panel; the at least one lateral spray assembly is operably moved between a folded position and an extended position; when the at least one lateral spray assembly is located at the folded position, the swinging arm is received in the at least one receiving groove; when the at least one lateral spray assembly is located at the extended position, the swinging arm is pivotally swung outward to disengage from the receiving grooves and radially extends from the sides of the shower panel; the shower head is able to spray water toward the shower space.

3. The extendable shower apparatus as claimed in claim 2, wherein the swinging arm comprises a first adjustable section and a second adjustable section; an end of the first adjustable section is connected to one of the at least one pivotally connecting portions of the shower panel, and another end of the first adjustable section is pivotally connected to the second adjustable section; the shower head is disposed on the second adjustable section; when the at least one lateral spray assembly is located at the folded position, the first adjustable section is overlapped with the second adjustable section.

4. The extendable shower apparatus as claimed in claim 3, wherein the first adjustable section has a first axis, and the second adjustable section has a second axis; when the at least one lateral spray assembly pivotally swing from the folded position to the extended position, the second adjustable section is tilted toward the shower space relative to the first adjustable section; a first angle formed between the first axis and the second axis is in a range of 10 to 50 degrees.

5. The extendable shower apparatus as claimed in claim 3, wherein the at least one lateral spray assembly is operably moved to a transitional position, the transitional position is located between the folded position and the extended position; when the at least one lateral spray assembly is located at the transitional position, the swinging arm is pivotally swung outward to disengage from the receiving groove, and a second angle formed between the first adjustable section and the second adjustable section is in a range of 10 to 80 degrees.

6. The extendable shower apparatus as claimed in claim 3, wherein each of two ends of the first adjustable section has a first connecting groove and a second connecting groove; the first adjustable section is connected to one of the pivotally connecting portions of the shower panel via the first connecting groove; an end of the second adjustable section has a pivotally connecting head, and the second adjustable section is connected to the second connecting groove of the first adjustable section via the pivotally connecting head.

7. The extendable shower apparatus as claimed in claim 6, wherein the first adjustable section has a protrusion which is disposed at an outer edge of the second connecting groove, and the second adjustable section has a recess which is disposed at a side of the pivotally connecting head; when the at least one lateral spray assembly is located at the folded position, the protrusion of the first adjustable section is received into the recess of the second adjustable section; when the at least one lateral spray assembly is pivotally swung to the extended position from the folded position, the protrusion of the first adjustable section is disengaged from the recess of the second adjustable section to allow the second adjustable section to be tiled by and abut against the protrusion of the first adjustable section.

8. The extendable shower apparatus as claimed in claim 2, wherein the shower panel comprises a spout that is engaged with a top portion of the body portion of the shower panel; the shower space is formed between the body portion and spout; the rain shower head is mounted to the spout and faces toward the shower space; the handheld shower is mounted at a bottom portion of the body portion of the shower panel.

9. The extendable shower apparatus as claimed in claim 2, wherein the shower panel comprises a body portion which has four receiving grooves; two of the four receiving grooves are located at one of the two sides of the body portion of the shower panel, and the other two of the four receiving grooves are located at another one of the two sides of the body portion of the shower panel; the shower panel is disposed with four pivotally connecting portions, each of the four pivotally connecting portions is located in one of the four receiving grooves; the at least one lateral spray assembly comprises four lateral spray assemblies, and each of the four lateral spray assemblies is able to be stored in one of the four receiving grooves.

10. The extendable shower apparatus as claimed in claim 9, wherein the body portion of the shower panel has four slots, and each of the four slots is respectively connected to one of the four receiving grooves and faces toward the shower space; when each of the four lateral spray assemblies is received in one of the four receiving grooves, the shower head of each of the four lateral spray assemblies is received in corresponding one of the slots.
